(19) United States
(12) Patent Application Publication
(10) Pub. No.: US 2026/0211263 A1
(43) Pub. Date: Jul. 23, 2026

(54) AIR FLOATING VIDEO DISPLAY APPARATUS

(71) Applicant: Maxell, Ltd., Kyoto (JP)

(72) Inventors: Toshimitsu WATANABE, Kyoto (JP); Sho ASAKURA, Kyoto (JP)

(73) Assignee: Maxell, Ltd., Kyoto (JP)

(21) Appl. No.: 19/140,366

(22) PCT Filed: Jan. 5, 2024
(86) PCT No.: PCT/JP2024/000083

§ 371 Date: Jun. 18, 2025

(30) Foreign Application Priority Data
Jan. 24, 2023 (JP) 2023-008800

(51) Int. Cl. G02B 30/56; G02B 27/09; G02B 27/14; G02B 27/28

(52) U.S. Cl. CPC G02B 30/56; G02B 27/0977; G02B 27/14; G02B 27/283

(57) ABSTRACT

The change in the relative display position of the air video to the observer partially loses the air floating video in view from the observer, and reduces the display area, and therefore, makes the user strongly feel uncomfortable. The present invention provides a configuration capable of displaying the air floating video not lost in the view from the observer even under the change in an observing position of the observer by arranging an optical member such as a specular-reflection mirror to form a path for a principal ray of light that is emitted from a video display, that passes through a reflection-type polarizer, that is reflected by a retroreflector, and that reaches eyes of the observer.

### TECHNICAL FIELD

The present invention relates to an air floating video display apparatus.

### BACKGROUND ART

For example, as disclosed in a Patent Document 1, an air floating information display apparatus includes: an image display; a reflection-type polarizer; a retroreflector; and a ¼ waveplate, and is configured to be capable of displaying an air video as a real image.

### RELATED ART DOCUMENT

### Patent Document

Patent Document 1: International Patent Publication No. WO/2016/088683

### SUMMARY OF THE INVENTION

### Problems to be Solved by the Invention

However, the disclosure of the Patent Document 1 does not describe the relative display position of the air video to the observer and the change in the display area of the air video, and the air video is partially lost in the view from the observer, and makes the user strongly feel uncomfortable. The present invention has been made in consideration of these circumstances, and an objective of the present invention is to provide a more suitable air floating video display apparatus.

### Means for Solving the Problems

In order to solve the above problems, according to one embodiment of the present invention, for example, it is sufficient to configure an air floating video display apparatus for displaying an air floating video so that an air floating video not lost in view from an observer can be displayed even under change in an observing position of the observer by arranging an optical member such as a specular-reflection mirror capable of forming a path for a primary ray of light that is emitted from a video display, that passes through a reflection-type polarizer, that is reflected by a retroreflector, and that reaches eyes of the observer.

### Effects of the Invention

According to the present invention, a more suitable air floating video display apparatus can be achieved.

### BRIEF DESCRIPTIONS OF THE DRAWINGS

FIG. 1 is a configurational diagram showing an air floating video display apparatus according to one embodiment of the present invention;

FIG. 2 is a diagram showing a basic operation of the air floating video display apparatus according to one embodiment of the present invention, the operation of displaying an air floating image of the first embodiment;

FIG. 3 is a diagram showing a positional relation between the air floating image of the first embodiment in the air floating video display apparatus according to one embodiment of the present invention and each member configuring the air floating video display apparatus;

FIG. 4 is a diagram showing a positional relation between an input video of the first embodiment in the air floating video display apparatus according to one embodiment of the present invention and each member configuring the air floating video display apparatus;

FIG. 5 is a diagram showing a positional relation between the air floating image of the first embodiment in the air floating video display apparatus according to one embodiment of the present invention and each member configuring the air floating video display apparatus;

FIG. 6 is a diagram showing a configuration of a second embodiment in the air floating video display apparatus according to one embodiment of the present invention;

FIG. 7 is a diagram showing a basic operation of the air floating video display apparatus according to one embodiment of the present invention, the operation of displaying an air floating image of the second embodiment;

FIG. 8 is a diagram showing a positional relation between an input video of the second embodiment in the air floating video display apparatus according to one embodiment of the present invention and each member configuring the air floating video display apparatus;

FIG. 9 is a diagram showing a positional relation between the air floating image of the second embodiment in the air floating video display apparatus according to one embodiment of the present invention and each member configuring the air floating video display apparatus;

FIG. 10 is a diagram showing a positional relation between the air floating image of the second embodiment in the air floating video display apparatus according to one embodiment of the present invention and each member configuring the air floating video display apparatus;

FIG. 11 is a diagram showing a configuration of a third embodiment in the air floating video display apparatus according to one embodiment of the present invention;

FIG. 12 is a diagram showing a basic operation of the air floating video display apparatus according to one embodiment of the present invention, the operation of displaying an air floating image of the third embodiment;

FIG. 13 is a diagram showing a positional relation between an input video of the third embodiment in the air floating video display apparatus according to one embodiment of the present invention and each member configuring the air floating video display apparatus;

FIG. 14 is a diagram showing a positional relation between the air floating image of the third embodiment in the air floating video display apparatus according to one embodiment of the present invention and each member configuring the air floating video display apparatus;

FIG. 15 is a diagram showing a configuration of a fourth embodiment in the air floating video display apparatus according to one embodiment of the present invention; and

FIG. 16 is a diagram showing a configuration of a fifth embodiment in the air floating video display apparatus according to one embodiment of the present invention.

### BEST MODE FOR CARRYING OUT THE INVENTION

Hereinafter, embodiments of the present invention will be described in detail with reference to the drawings. Note that the present invention is not limited to the explanations for embodiments, and various modifications and alterations can be made within the scope of the technical ideas disclosed in the present specification by those who skilled in the art. Also, components having the same function are denoted by the same reference symbols throughout all the drawings for describing the present invention, and the repetitive description thereof will be omitted.

In the following explanation for the embodiments, the floating video in air is expressed as a term “air floating video”. In place of this term, this may be expressed as “air image”, “aerial image”, “aerial floating video”, “aerial floating optical image of display video”, “air floating optical image of display video”, or others. The term “air floating video” mainly used in the explanation for the embodiments is used as a typical example of these terms.

### First Embodiment

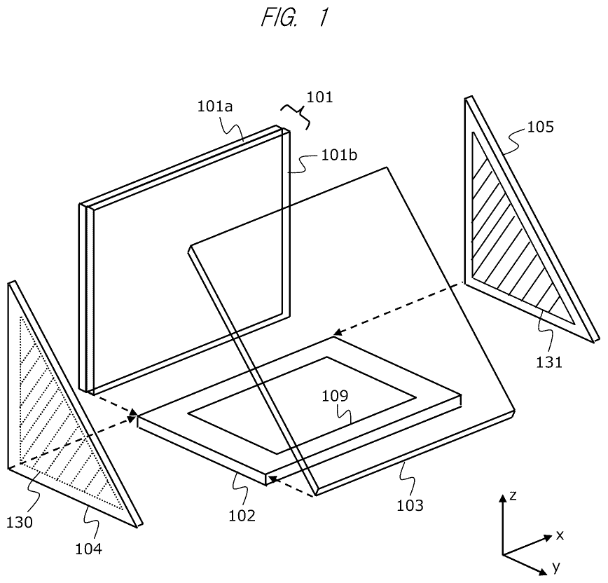

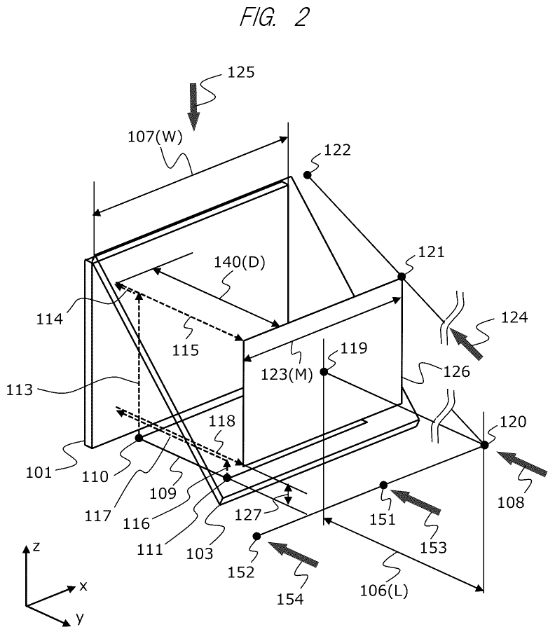

FIG. 1 is a diagram showing an entire configuration of an air floating video display apparatus according to one embodiment of the present invention. The present embodiment provides a configuration capable of displaying the air floating video not lost in the view from the observer even under the change in the observing position of the observer by arranging the optical member such as the specular-reflection mirror to form the path for the principal ray of light that is emitted from the video display, that passes through the reflection-type polarizer, that is reflected by the retroreflector, and that reaches eyes of the observer. Specific configuration and operation of the air floating video display apparatus will be described in detail with reference to FIGS. 2, 3, 4 and 5.

The air floating video display apparatus includes a retroreflection plate 101, a video display 102, a reflection-type polarizer 103 and side plates 104 and 105. Each side plate may be also referred to as a shielding plate. The retroreflection plate 101 has a structure including double layer made of a retroreflector 101a and a λ/4 waveplate 101b (quarter waveplate). The video display 102 of the present embodiment includes a light source and a display panel. Respective inner regions 130 and 131 of the side plates 104 and 105 on the video display 102 side are covered with a specular-reflector or a retroreflector. The video 109 indicates a video display region displayed on the video display 102.

FIG. 2 is a diagram showing a basic operation of displaying the air floating image. Specific polarized light components of principal rays 113 and 116 emitted from two corner points 110 and 111 of the video 109 are reflected by the reflection-type polarizer 103, become principal rays 114 and 117, and travel to the retroreflection plate 101. Since the retroreflection plate 101 performs the retroreflection, the principal rays 114 and 117 travel as principal rays 115 and 118 in an opposite direction to that of the principal rays 114 and 117. In this case, the principal rays 115 and 118 rotate by 90 degrees in terms of a polarization direction when passing through the λ/4 waveplate 101b twice, and therefore, pass through the reflection-type polarizer 103, and reach two corner points of the air floating image 126. Other rays than the principal rays also reach the same position because of the same path, and therefore, the display video surface of the video 109 forms the display surface as the air floating image 126.

In this case, a distance 127 indicates an air floating distance. A position away by a distance 106 in a normal-line direction at a center point 119 of the air floating image 126 is set to an observing position 120. Points away by a predetermined distance in an “x” direction of the observing position 120 are illustrated as observing positions 151 and 152. Arrows 108, 124, 125, 153 and 154 indicate directions of a line of sight.

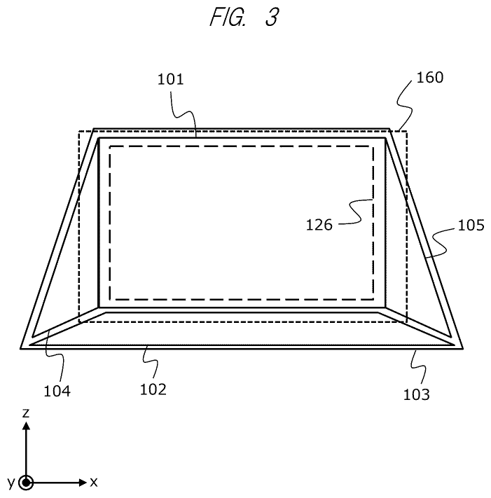

FIG. 3 is a diagram showing a positional relation between the air floating image 126 in the view in the direction of the arrow 108 and each member configuring the air floating video display apparatus. In FIG. 3, the air floating image 126 is illustrated in a case with a sufficient large distance 106, while an air floating image 160 is illustrated as a relative display size in case with a small distance 106. Upper right and upper left of the air floating image 160 are beyond the outside portions of the reflection-type polarizer 103, and the air floating image is partially lost. In order to prevent the lost image, in FIG. 2, an arrow 124 indicates an observing direction from the point 120 toward a point 121 of an upper right corner of the air floating image 126, and a point 122 on its extension line needs to pass through the reflection-type polarizer 103 and be positioned on a surface of the retroreflection plate 101. However, if the distance 106 is small, the point 122 is not positioned on the surface of the retroreflection plate 101, and therefore, the image is lost. In order to prevent the lost image, the retroreflection plate 101 and the reflection-type polarizer 103 need to be sufficiently large, and thus, such a size is estimated. As illustrated in FIGS. 2, 3, 10 and others, if an x-direction size 107 of the retroreflection plate 101 is assumed to “W”, a distance 140 between the retroreflection plate 101 and the air floating image 126 is assumed to “D”, an x-direction size 123 of the air floating image 126 is assumed to “M”, and the distance 106 is assumed to “L”, then, the “L” required for the display of the air floating image 160 is expressed by the following formula 1.

$$W > M \cdot ( L + D ) / L \qquad Formula 1$$

In a case of air floating display with an aspect ratio of 16:9 and about 10-inch diagonal size (it is assumed that a floating distance 127=30 mm), D=140 mm while M=222 mm. If L=600 mm, the following formula 2 is established, and the “W” needs to be about 1.24 times the original one.

$$W > 274 mm \qquad Formula 2$$

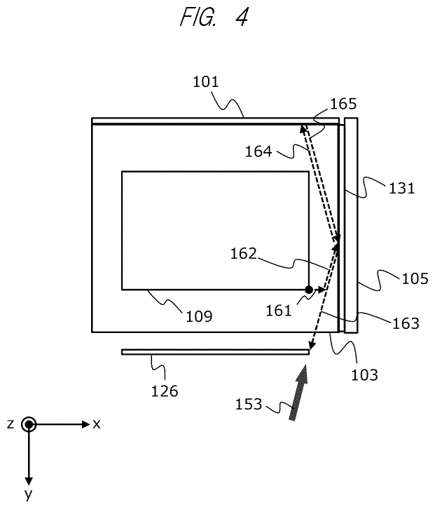

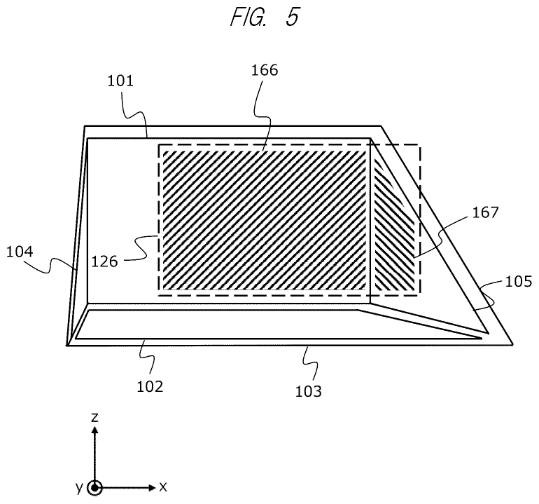

Practically, an image of the air floating image is lost by movement of the observing point from the position of the point 120 of FIG. 2 to points 151 and 152, and therefore, it is required to not only make the retroreflection plate 101 and the reflection-type polarizer 103 larger but also make the air floating video display apparatus large. If the formula 1 is not satisfied, the image of the air floating image is lost. However, as means for avoiding the lost image, the specular-reflector or the retroreflector is used for inner regions 130 and 131 of the side plates 104 and 105. This function will be explained with reference to FIGS. 4 and 5.

FIG. 4 is a diagram showing a positional relation between an image 109 observed in a direction of the arrow 125 and each member configuring the air floating video display apparatus. FIG. 5 is a diagram showing a positional relation between the air floating image 126 observed in a direction of the observing-point position 153 of the point 151 and each member configuring the air floating video display apparatus.

In FIG. 4, if the retroreflection plate (the retroreflector and the λ/4 waveplate) is used for the region 131, the light emitted from the corner point of the video 109 becomes as the principal ray arrow 161, is reflected by the reflection-type polarizer 103, and becomes as the principal ray arrow 162. The principal ray arrow 162 is retroreflected by the region 131, and rotates in terms of the polarization direction by 90 degrees, and, as a result, becomes as the principal ray arrow 163, is transmitted through the reflection-type polarizer 103, travels in the observing direction 1513, and forms the corner point of the air floating image 126. If the region 131 is made of the specular-reflector, the principal ray of the arrow 162 becomes as the arrow 164, and travels to the retroreflection plate 101, and is retroreflected as the arrow 165, is specular-reflected again, becomes as the principal ray arrow 163, is transmitted through the reflection-type polarizer 103, and travels in the observing direction 153, and then, forms the corner point of the air floating image 126.

FIG. 4 is a diagram in view in a “z” direction, and a positional relation with each member in view from a practical observing-point position is illustrated in FIG. 5. The air floating image 126 illustrated with a dotted line frame is made of a region 166 relatively moved in the x direction and allowed to be displayed only within the range of the retroreflection plate 101. However, when the specular-reflector or the retroreflection plate is used for the inner surface of the side plate 105, it is found that the air floating image can be displayed in a region 167. If the specular-reflector is used for the regions 130 and 131, it is necessary to keep about 90 degrees as an attachment angle relative to a plane made of the video 109 for keeping continuity between the regions 166 and 167 in FIG. 5. However, when the retroreflection plate is used for the regions 130 and 131, there is no limitation of the attachment angle relative to the plane made of the video 109 and the reflection-type polarizer 103.

### Second Embodiment

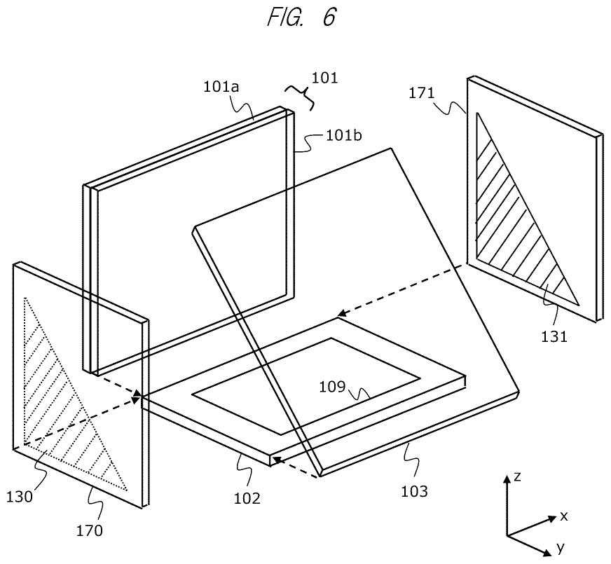

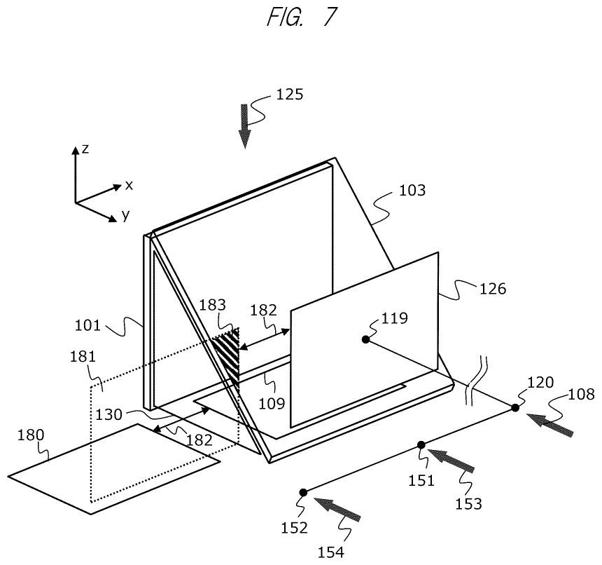

FIG. 6 is a diagram showing a second embodiment in the air floating video display apparatus according to one embodiment of the present invention. The specific basic configuration and operation of the air floating video display apparatus will be described in detail with reference to FIGS. 7, 8, 9 and 10. The air floating video display apparatus is made of the retroreflection plate 101, the video display 102, the reflection-type polarizer 103, and side plates 170 and 171. Respective inner regions 130 and 131 of the side plates 170 and 171 on the video display 102 side are covered with the specular-reflector or the retroreflector. The video 109 indicates the video display region displayed on the video display 102.

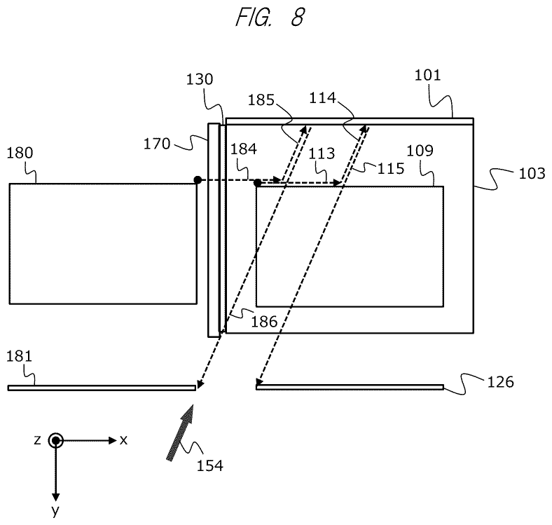

FIG. 7 is a diagram showing the basic operation of displaying the air floating image. The side plates 170 and 171 are different in a shape from the side plates 104 and 105 of FIG. 1. This difference will be explained with reference to FIGS. 7 and 8.

In FIG. 7, the video 109 is displayed as the air floating image 126 by using the retroreflection plate 101 and the reflection-type polarizer 103 as explained with reference to FIG. 2. In the case of the use of the specular-reflector for the region 130, if the observing point moves from the point 151 to the point 152, a virtual image 180 as a virtual image of the video 109 is formed at a position symmetric and away by a distance 182 to the region 130. This virtual image 180 is transmitted through the reflection-type polarizer 103 and the retroreflection plate 101, and forms a new air floating image 181 at the position away by the distance 182 on the same plane as that of the air floating image 126. In the observing direction 154 at the point 152, an air floating image 183 is observed as a part of the air floating image 181. The video source of the air floating image 183 is the virtual image of the video 109, and therefore, the air floating image 183 is symmetric to the air floating image 126. Therefore, if the displayed information includes text (letter) information, the horizontally-symmetric mirror text is formed, and thus, becomes an obstacle image. Therefore, a devisal for making the air floating image 183 unobservable in the observing direction 154 is needed.

FIG. 8 is a diagram showing a positional relation among the video 109 observed in a direction of the arrow 125, the virtual image 180 and each member configuring the air floating video display apparatus. The principal ray emitted from the upper left corner point of the video 109 is reflected and transmitted as sequentially illustrated as the arrows 113, 114 and 115, and reaches the position of the air floating image 126. Also, the principal ray emitted from the corner point of the virtual image 180 is reflected and transmitted as sequentially illustrated as the arrows 184, 185 and 186, and reaches the position of the air floating image 181. The side plate 170 functions to shield the principal ray arrow 186 to prevent the formation of the air floating image 181 in the observing direction 154.

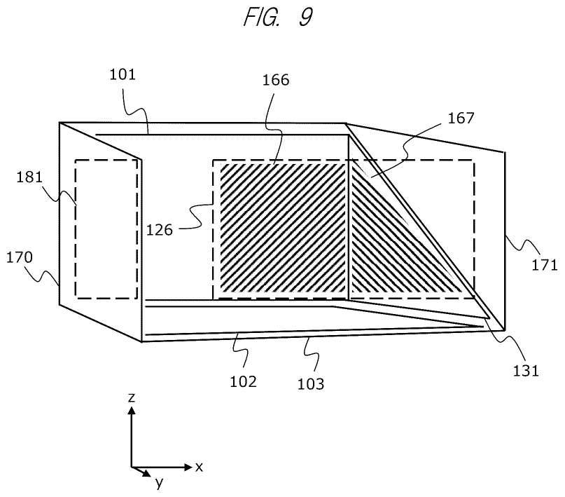

FIG. 9 is a diagram showing a positional relation between the air floating image 126 observed in a direction of the observing-point position arrow 154 at the point 152 and each member configuring the air floating video display apparatus. The air floating image 126 of the video 109 is displayed within the range of the regions 166 and 167, while the air floating image 181 made of the virtual image is not displayed because of a shielding effect of the side plate 170.

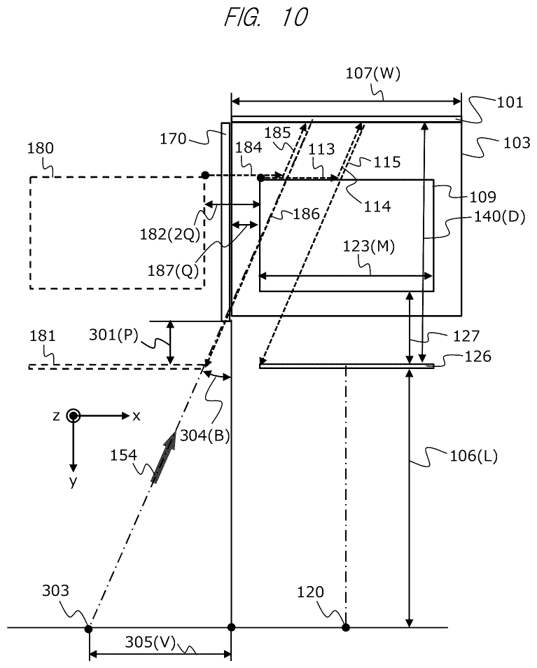

A depth-directional length of the side plate 170 of FIG. 8 is significant for the efficient shield relative to the observing-point position. A condition for determining the depth-directional length of the side plate 170 will be explained with reference to FIG. 10. FIG. 10 is illustrated so that an end position of the side plate 170 required for the plane position of the air floating image 126 in FIG. 8 is defined as a length 301 while an observing-point position 303 is defined as a position of the side plate 170 moved outward by a length 305. In FIG. 10, when the side plate 170 is arranged on the opposite side, in other words, when the side plates 170 and 171 are arranged on both sides as illustrated in FIG. 9, if a width 107 of the retroreflection plate 101 is assumed to “W”, a width 123 of the video 109 is assumed to “M”, an angle 304 made by the end of the side plate 170 reaching from the observing-point position 303 and an extension line of the side plate 170 is assumed to “B”, a distance 182 between the video 109 and the virtual image 180 is assumed to “20”, and a distance 187 between the side plate 170 and the video 109 is assumed to “Q”, then, the following formula 4 is established in a range of the following formula 3.

$$V > Q \qquad Formula 3$$

$$tan ( B ) = ( V - Q ) / L \qquad Formula 4$$

In these formulas, the length 305 is assumed to “V”, and a y-directional length 106 extending from the plane of the air floating image 126 to the observing-point position 303 is assumed to “L”. If the length 301 is assumed to “P”, the “P” is expressed by the following formula 5.

$$Q / P = tan ( B ) \qquad Formula 5$$

The video 109 is set at an almost center position of the retroreflection plate 101, and therefore, the following formula 6 is established.

$$2 Q = W - M \qquad Formula 6$$

A relational formula among P, L and V derived from the formulas 3 to 6 can be expressed as the following formula 7.

$$P = L \cdot ( W - M ) / ( 2 V - ( W - M ) ) \qquad Formula 7$$

Note that the “Q” can be also expressed as a distance between the side plate 170 and the air floating image 126.

For example, when it is assumed that “L=600 mm”, that “M=222 mm” and that “W=250 mm”, “P=45.2 mm” is derived at “V=200 mm”, and therefore, the depth-directional length of the side plate 170 may be determined as a position recessed by 45.2 mm from the plane where the air floating image is formed.

In FIGS. 9 and 10, note that the distance 187 between the side plate 170 and the video 109 and the distance between the side plate 170 and the video 109 may be equal to or different from each other.

In FIG. 10, when the side plate 170 is arranged on only one side, if the distance 187 between the side plate 170 and the video 109 is assumed to “Q”, the length 301 is assumed to “P”, the distance 106 is assumed to “L”, and the length 305 is assumed to “V”, then, the following formula 8 is established.

$$P = L \cdot Q / ( V - Q ) \qquad Formula 8$$

### Third Embodiment

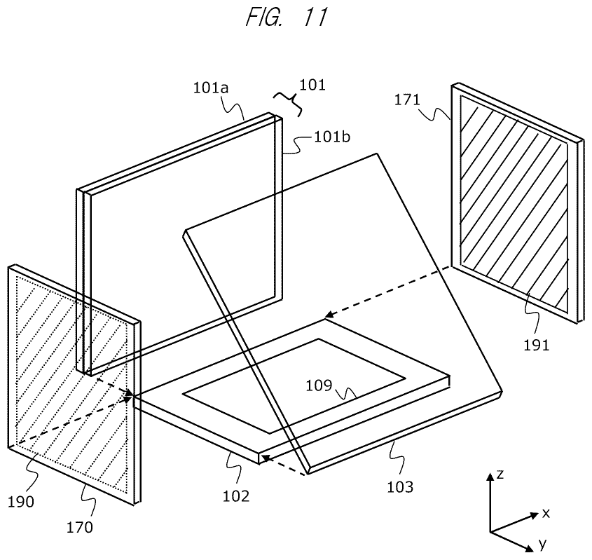

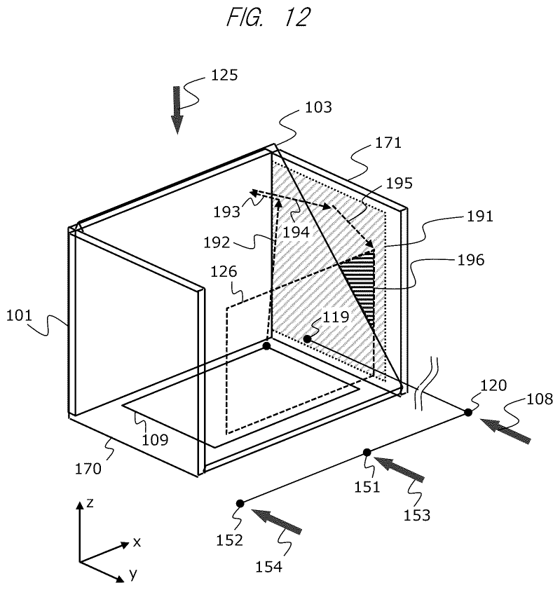

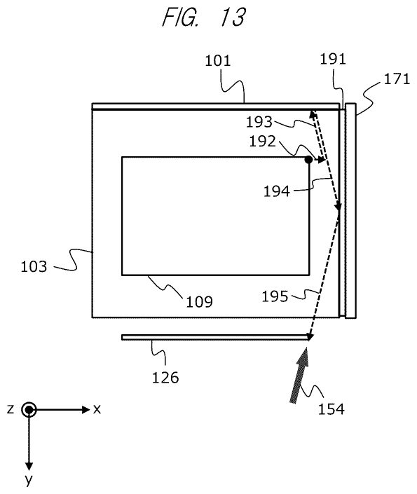

FIG. 11 is a diagram showing a third embodiment in the air floating video display apparatus according to one embodiment of the present invention. The specific basic configuration and operation of the air floating video display apparatus will be described in detail with reference to FIGS. 12 and 13. The air floating video display apparatus is made of the retroreflection plate 101, the video display 102, the reflection-type polarizer 103, and the side plates 170 and 171. Respective inner regions 190 and 191 of the side plates 170 and 171 on the video display 102 side are covered with the specular-reflector. The video 109 indicates the video display region displayed on the video display 102. The regions 190 and 191 are different in a shape from the regions 130 and 131 on the inner surfaces of the side plate 170 and 171 of FIG. 6. This difference will be explained in detail with reference to FIGS. 12, 13 and 14.

FIG. 11 is a diagram showing the basic operation of displaying the air floating image. The video 109 is displayed as the air floating image 126 by using the retroreflection plate 101 and the reflection-type polarizer 103 as explained with reference to FIG. 2. In the case of FIG. 12, in the observation at the observing point of the point 152, the air floating image is not displayed on a back surface of a portion illustrated as a region 196 because the reflection-type polarizer 103 does not exist. However, if the specular-reflector is used for the region 191, the air floating image can be displayed in the region 196 by the functions of the principal rays 192, 193, 194 and 195. Also, the side plates 170 and 171 may be separated to be on a portion of the reflection-type polarizer (beam splitter) 103 on the air floating image 102 side and another portion of the reflection-type polarizer (beam splitter) 103 on the user side, or may be not separated.

FIG. 13 is a diagram showing a positional relation among the video 109 observed in the direction of the arrow 125, the air floating image 126 and each member configuring the air floating video display apparatus. The principal ray of the arrow 192 emitted from the corner point of the video 109 is reflected by the reflection-type polarizer 103, travels to the retroreflector sheet 101 in the direction of the arrow 193, is retroreflected to become the principal ray arrow 194 rotated in terms of the light polarization, is transmitted through the reflection-type polarizer 103, and then, becomes as the principal ray arrow 195 because of the specular-reflector of the region 191, and reaches the air floating image 126, and thus, can be visually recognized by the observer in the direction of the arrow 154.

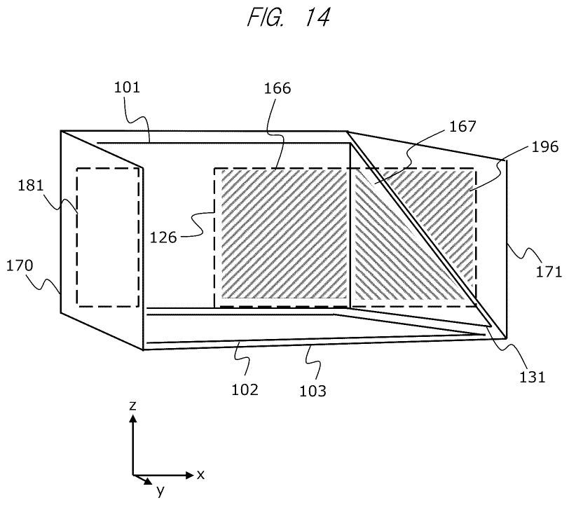

FIG. 14 is a diagram showing a positional relation between the air floating image 126 observed in the direction of the observing-point position arrow 154 of the point 152 and each member configuring the air floating video display apparatus. The air floating image 126 of the video 109 is displayed within the range of the regions 166, 167 and 196, while the air floating image 181 made of the virtual image is not displayed because of a shielding effect of the side plate 170. If the specular-reflector is used for the regions 190 and 191, it is necessary to keep about 90 degrees as an attachment angle relative to a plane made of the video 109 for keeping continuity among the regions 126, 167 and 196 in FIG. 14.

### Fourth Embodiment

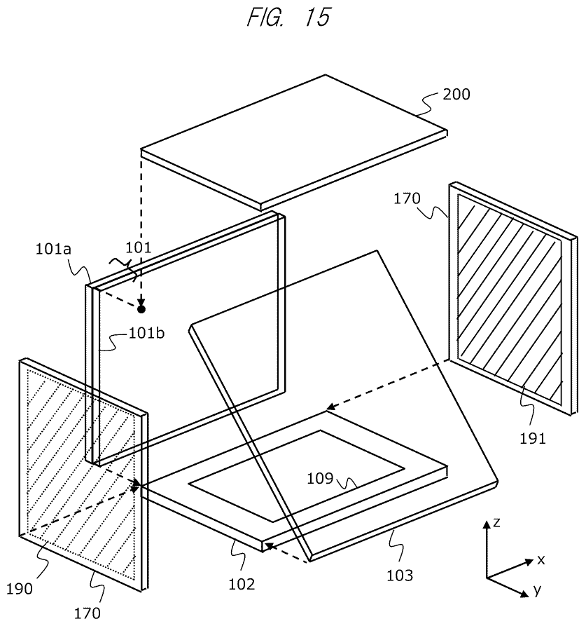

FIG. 15 is a diagram showing a fourth embodiment in the air floating video display apparatus according to one embodiment of the present invention. In FIG. 15, an upper cover 200 is added to the configuration of FIG. 11. Almost 100% of the area of the air floating image can be displayed by the effect of the regions 190 and 191. However, since the regions 190 and 191 are made of the specular-reflector, the light from the external lighting such as a ceiling light or the like may directly enter the eyes of the observer in the practical use. Therefore, the upper cover 200 functions to shield the external lighting.

### Fifth Embodiment

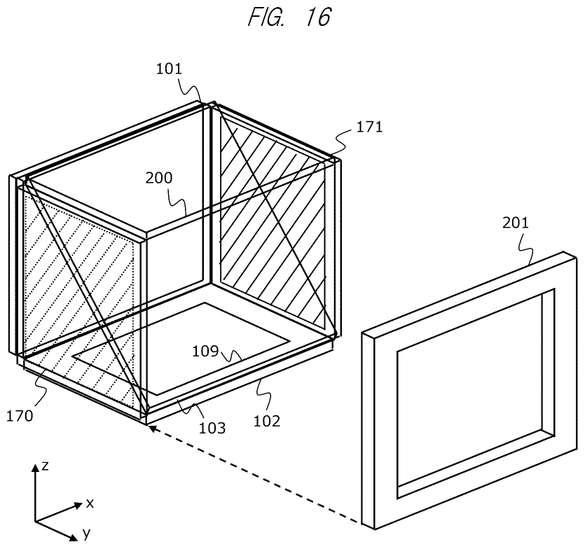

FIG. 16 is a diagram showing a fifth embodiment in the air floating video display apparatus according to one embodiment of the present invention. In FIG. 16, a front cover 201 is added to the configuration of FIG. 15. A visually recognizable range for the observer is expanded by the effect of the regions 190 and 191, and therefore, almost 100% of the area of the air floating image can be displayed. Therefore, a size of an opening of the front cover 201 can be made almost equal to the display size of the video 109. Therefore, the high-quality air floating image can be displayed regardless of usage environment.

As described above, in the present embodiment, the side plate may be arranged on only one side or both sides.

The air floating video display apparatus in the case of the side plate arranged on only one side includes: the video display (video display device) 102; splitter the beam (reflection-type polarizer) 103 that reflects part of the video light emitted from the video display 102; the retroreflection plate 101 that retroreflects the light reflected from the beam splitter 103; and the side plate 170 (or the side plate 171, 104 or 105) arranged to cover a space surrounded by the video display 102, the beam splitter 103 and the retroreflection plate 101, from at least either right or left side, the light retroreflected by the retroreflection plate 101 is transmitted through the beam splitter 103, and forms the air floating video 126, and a surface of the side plate 170 is made of a reflector, the surface facing the space surrounded by the video display 102, the beam splitter 103 and the retroreflection plate 101.

The beam splitter 103 is the reflection-type polarizer, and the reflector formed on the surface of the side plate 170, the surface facing the space surrounded by the video display 102, the beam splitter 103 and the retroreflection plate 101, may be made of a double-layer structure of the λ/4 waveplate and the retroreflector, or made of the specular-reflector.

As illustrated in FIG. 8, 9 or others, a portion of the side plate extends toward the user side of the beam splitter 103 to shield the position of the display of the second air floating image 181 made of the virtual image 180 of the video 109 emitted from the video display 102, and the specular-reflector is arranged on the surface on the video display side at the extending portion as well as the surface of the side plate 170 facing the space surrounded by the video display 102, the beam splitter 103 and the retroreflection plate 101.

If a distance from the air floating image in the normal line direction for the observation is assumed to “L”, a distance from the side plate in a horizontal direction for the outward observation is assumed to “V”, and a distance between the side plate and the air floating image 126 is assumed to “Q”, then, the depth-directional length of the side plate is at a position recessed by a distance defined by “L·Q/(V−Q)” from the display surface of the second air floating image 181.

Further, a top panel cover formed by connecting upper ends of the side plate 170 and the retroreflection plate 101 may be arranged on a surface facing the video display 102, or a front cover having an opening of the same size as that of the video display 102 may be arranged at a position of the display of the air floating image 126.

The air floating video display apparatus in the case of the side plates arranged on both sides includes: the video display 102; the beam splitter 103 that reflects part of the video light emitted from the video display 102; the retroreflection plate 101 that retroreflects the light reflected from the beam splitter 103; and two facing side plates that cover a space surrounded by the video display 102, the beam splitter 103 and the retroreflection plate 101, from both the right and left sides, the light retroreflected by the retroreflection plate 101 is transmitted through the beam splitter 103, and forms the air floating video 126, and the facing surfaces of two side plates 170 and 171 (or the side plates 104 and 105) are made of a reflector.

The beam splitter 103 is the reflection-type polarizer, and the reflector formed on the facing surfaces of two side plates may be made of a double-layer structure of the λ/4 waveplate and the retroreflector, or made of the specular-reflector.

As illustrated in FIG. 8, 9 or others, each portion of the two side plates 170 and 171 extends toward the user side of the beam splitter 103 to shield the position of the display of the second air floating image 181 made of the virtual image 180 of the video 109 emitted from the video display 102, and the specular-reflector is arranged on the facing surfaces of the two side plates 170 and 171 at the extending portions as well as the facing surfaces of the two side plates.

If a distance from the air floating image in the normal line direction for the observation is assumed to “L”, a distance from the side plate in a horizontal direction for the outward observation is assumed to “V”, and a distance between the side plate and the air floating image 126 is assumed to “Q”, then, the depth-directional length of the side plate is at a position recessed by a distance defined by “L·Q/(V−Q)” from the display surface of the second air floating image 181. In other words, if the width of the video display 102 is assumed to “M”, the width of the retroreflection plate 101 is assumed to “W”, a distance from the air floating image 126 in the normal line direction for the observation is assumed to “L”, a distance from the side plate in a horizontal direction for the outward observation is assumed to “V”, then, the depth-directional length of the side plate is at a position recessed by a distance defined by “L·(W−M)/(2V−(W−M))” from the display surface of the second air floating image 181.

Further, a top panel cover formed by connecting upper ends of the side plates 170 and 171 may be arranged on a surface facing the video display 102, or a front cover having an opening of the same size as that of the video display 102 may be arranged at a position of the display of the air floating image 126.

In the technique according to the present embodiments, since the video information is displayed to be aerially floating, for example, the user can perform operations without concern about contact infection in illness by taking combination with a contactless finger position detector or the like. When the technique according to the present embodiments is applied to the system that is used by a large number of unspecified users, a contactless user interface having the less risk of the contact infection in illness and being available without the concern can be provided. Such a technique contributes to “the third goal: Good Health and Well-being (for all people)” of the Sustainable Development Goals (SDGs) advocated by the United Nations.

The technique according to the present embodiments can provide the bright uniform air floating video. In the technique according to the present embodiments, a contactless user interface excellent in the energy efficiency can be provided. Such a technique contributes to “the ninth goal: Industry, Innovation and Infrastructure” and “the eleventh goal: Sustainable Cities and Communities” of the Sustainable Development Goals (SDGs) advocated by the United Nations.

Various embodiments have been concretely described above. However, the present invention is not limited to the foregoing embodiments, and includes various modifications. For example, in the above-described embodiments, the entire system has been explained in detail for supporting understanding of the present invention, and is not always limited to the one including all structures explained above. Also, a part of the structure of one embodiment can be replaced with the structure of another embodiment, and besides, the structure of another embodiment can be added to the structure of one embodiment. Further, another structure can be added to/eliminated from/replaced with a part of the structure of each embodiment.

### EXPLANATION OF REFERENCE CHARACTERS

101 . . . retroreflection plate, 101a . . . retroreflector, 101b . . . . Δ/4 waveplate, 102 . . . video display (video display portion), 103 . . . reflection-type polarizer (beam splitter), 104 . . . side plate, 105 . . . side plate, 109 . . . video, 126 . . . air floating image, 130 . . . region (reflector), 131 . . . region (reflector)

1. An air floating video display apparatus comprising:
a video display;
a beam splitter configured to reflect a part of video light emitted from the video display;
a retroreflection plate configured to retroreflect light reflected by the beam splitter; and
a side plate arranged to cover a space surrounded by the video display, the beam splitter and the retroreflection plate, from at least either right or left side,
wherein light retroreflected by the retroreflection plate is transmitted through the beam splitter, and forms an air floating video, and
a surface of the side plate, the surface facing the space, is made of a reflector.

2. The air floating video display apparatus according to claim 1,
wherein the retroreflection plate is made of a double-layer structure of a λ/4 waveplate and a retroreflector, and
the beam splitter is a reflection-type polarizer.

3. The air floating video display apparatus according to claim 2,
wherein the reflector formed on the surface of the side plate, the surface facing the space, is made of the double-layer structure of the λ/4 waveplate and the retroreflector.

4. The air floating video display apparatus according to claim 2,
wherein the reflector formed on the surface of the side plate, the surface facing the space, is a specular-reflector.

5. The air floating video display apparatus according to claim 4,
wherein an angle made by a video-light emission surface of the video display and the surface of the side plate, the surface made of the specular-reflector and facing the space, is 90 degrees.

6. The air floating video display apparatus according to claim 4,
wherein the side plate extends to a user side of the beam splitter to shield a position at which the video emitted from the video display displays a second air floating image.

7. The air floating video display apparatus according to claim 6,
wherein, if a distance from the air floating image in a normal line direction for observation is assumed to “L”, a distance from the side plate in a horizontal direction for outward observation is assumed to “V”, and a distance between the side plate and the air floating image is assumed to “Q”, then, a depth-directional length of the side plate is at a position recessed by a distance defined by “L·Q/(V−Q)” from a display surface of the second air floating image.

8. The air floating video display apparatus according to claim 6,
wherein a specular-reflector is arranged on a surface of a portion of the side plate, the surface facing the space, the portion extending to a user side of the beam splitter.

9. The air floating video display apparatus according to claim 8,
wherein a top panel cover is arranged on a plane facing the video display and connecting upper ends of the side plate and the retroreflection plate.

10. The air floating video display apparatus according to claim 9,
wherein a front cover having an opening of the same size as a size of the video display is arranged at a position of display of the air floating image.

11. An air floating video display apparatus comprising:
a video display;
a beam splitter reflecting a part of video light emitted from the video display;
a retroreflection plate retroreflecting light reflected by the beam splitter; and
two side plates arranged while facing each other to cover a space surrounded by the video display, the beam splitter and the retroreflection plate, from both right and left sides,
wherein light retroreflected by the retroreflection plate is transmitted through the beam splitter, and forms an air floating video, and
facing surfaces of the two side plates are made of a reflector.

12. The air floating video display apparatus according to claim 11,
wherein the retroreflection plate is made of a double-layer structure of a λ/4 waveplate and a retroreflector, and
the beam splitter is a reflection-type polarizer.

13. The air floating video display apparatus according to claim 12,
wherein the reflector formed on the facing surfaces of the two side plates is made of the double-layer structure of the λ/4 waveplate and the retroreflector.

14. The air floating video display apparatus according to claim 12,
wherein the reflector formed on the facing surfaces of the two side plates is a specular-reflector.

15. The air floating video display apparatus according to claim 14,
wherein an angle made by a video-light emission surface of the video display and the surface of the side plate, the surface made of the specular-reflector and facing the space, is 90 degrees.

16. The air floating video display apparatus according to claim 14,
wherein the two side plates extend to a user side of the beam splitter to shield a position at which the video emitted from the video display displays a second air floating image.

17. The air floating video display apparatus according to claim 16,
wherein, if a distance from the air floating image in a normal line direction for observation is assumed to “I”, a distance from the side plate in a horizontal direction for outward observation is assumed to “V”, and a distance between the side plate and the air floating image is assumed to “Q”, then, a depth-directional length of the side plate is at a position recessed by a distance defined by “L·Q/(V−Q)” from a display surface of the second air floating image.

18. The air floating video display apparatus according to claim 16,
wherein, if a width of the video display is assumed to “M”, a width of the retroreflection plate is assumed to “W”, a distance from the air floating image in a normal line direction for observation is assumed to “L”, a distance from the side plate in a horizontal direction for outward observation is assumed to “V”, then, a depth-directional length of the side plate is at a position recessed by a distance defined by “L·(W−M)/(2V−(W−M))” from a display surface of the second air floating image.

19. The air floating video display apparatus according to claim 16,
wherein a specular-reflector is arranged on the facing surfaces of portions of the two side plates, the portions extending to a user side of the beam splitter.

20. The air floating video display apparatus according to claim 19,
wherein a top panel cover is arranged on a plane facing the video display and connecting upper ends of the two side plates.

21. The air floating video display apparatus according to claim 20,
wherein a front cover having an opening of the same size as a size of the video display is arranged at a position of display of the air floating image.
